(19) United States
(12) Patent Application Publication
(10) Pub. No.: US 2008/0050704 A1
(43) Pub. Date: Feb. 28, 2008

(54) Computer-aided method for guided teaching of language

(76) Inventors: Kitty Kit King Hau, Hong Kong (HK); Howard Shi Kin Wan, Hong Kong (HK); Nicholas Yin Chung Wong, Hong Kong (HK)

Correspondence Address: VEDDER PRICE KAUFMAN & KAMMHOLZ, 222 N. LASALLE STREET, CHICAGO, IL, 60601, US

(21) Appl. No.: 11/501,974

(22) Filed: Aug. 10, 2006

(51) Int. Cl. G09B 19/00

(52) U.S. Cl. 434/156

(57) ABSTRACT

The present invention is a computer aided method for guided teaching of language between a teacher and a class of students in a guided teaching session, comprising the steps of: (a) presenting a question to the student at a student display; (b) receiving input from the teacher at the teacher workstation for the teacher to give further information related to the question; (c) presenting information using at least one of a plurality of styles and stimuli corresponding to the input from the teacher on the student display; (d) receiving answer from the teacher at the teacher workstation, wherein the answer is received by the teacher from the student; (e) determining whether the answer is correct; and (f) presenting feedback to the answer at student display. In the guided teaching session, after presenting a question to the students, the teacher may further provide guidance to the students on the student display to assist the students in reaching the correct answer.

This non-provisional application is based on provisional application Ser. No. 60/725,859, filed Oct. 1, 2005.

### TECHNICAL FIELD

The present invention relates generally to a computer-aided method for teaching and training, and a system to implement such method. In particular, the present invention relates to guided teaching in, for example, teaching a language to non-native speakers of the language, which combines the guidance of a teacher and the teaching materials presented in an interactive, audio-visual manner.

### BACKGROUND

As the new generation is exposed to using computer as a communication means, instant messaging software is popular among students as a communication outside the classroom. Students are also used to the audio-visual stimulation common in most video games. Many automated teaching systems adopting a computer game format have been created to replace the conventional classroom method and to make learning a more attractive and enjoyable experience to students.

In teaching language, for example, a teaching approach is for the student to do exercises related to the words to be taught. The student may be asked to give a definition of a word, fill a word in a blank part of a passage, or to identify a picture related to a specific word, while a number of answers are given for the student to choose from. There are existing software packed with graphics and sound effects using such approach to enhance learning effectiveness that may be able to arouse the student's interest in doing the exercise. However, the value of those software can be doubtful if appropriate guidance in reaching the correct answer sensibly is not provided, as the student may simply make wild guesses and be frustrated by repeatedly failed attempts to arrive at the right answer, losing motivation to participate as a whole.

Hence, a main disadvantage of such automated teaching method is that it lacks the human touch and the guidance from a teacher, which are the crucial elements that these products have thus far failed to capture from the conventional teaching method. The guidance of a teacher serves to guide the student back on the right track to think sensibly when a wrong answer is selected by leading the student through a brainstorming process, using additional data or hint that can assist the student to reach the correct answer in a sensible manner but not by wild guessing. Such discussion creates a bond between teacher and students and forms a friendly, appealing and interactive learning atmosphere, which is only found in conventional classroom approach.

There are drawbacks however in conventional classroom approach that has to be refined using modern technology. The major one perhaps is the pre-requisite for the teacher to be very proficient in all aspects of the subject matter. Due to the complexity of some subjects such as language, it very often takes exhaustive training to groom high caliber teachers who shall have a strong grasp of grammar as well as the intuition for application of the language. Hence, it makes sense to have a system that can equip the teacher with preloaded data and answer keys to support his teaching, with which the teacher is able to gradually pick up more knowledge about a particular subject matter as he uses the system to teach along. That way, teacher can focus on playing the role as a facilitator to guide the students through an interactive learning process, and be released from the cumbersome task of digesting the details before giving the lesson.

Moreover, globalization has called for increased international communication. A few languages, such as English and Mandarin, are becoming more popularly used around the world, which in turn leads to an increase in the demand of language teachers to teach non-native speakers. A user-friendly teaching system is required to reduce the training period of the teachers.

The time consuming method of manually gathering information and statistics on classroom experience to refine the curriculum can be streamlined by educational software storing such valuable information generated by teachers and students automatically.

Though a pre-loaded syllabus and teaching content pool is preferred, flexibility for sharing teaching materials among different teachers and students should be emphasized. The teacher himself may sometimes have much insight to offer in teaching a particular subject matter. The same situation applies to students too. In teaching vocabulary, for example, a student may have created a sentence to demonstrate the use of a word that is worth sharing with the students in other classes, on the other hand, may have misunderstood the usage of another word that can be applied as teaching material so that the other students can learn from sharing such mistake. One can imagine how many creative examples of vocabulary application and teaching ideas have gone down the drain due to the inability of educational systems to capture and share them amongst the teachers and students. In other words, an effective teaching system should not only restrict learning from the input of the teacher and the students in one class, but should also facilitate the sharing of such input in a larger scale, covering classes taking the same course within a school using the same LAN, or even schools teaching the same course using the same WAN.

A system should be provided to display preloaded data in a structured and sequential manner so that it can up-keep a curriculum systematically to be delivered in a pre-set manner, avoiding the additional hints delivered by one teacher to deviate much from another. In addition, when a teacher departs or is absent, the substitute teachers can readily assume his role using the same system loaded with teaching materials to be delivered in manner already adapted by the students.

Due to the many distractions facing youngsters today, students' abilities to learn have dropped significantly. To enhance teaching effect, some times the school would need to give extra support to the slower performers. There should be a system that allows tutorial sessions to be carried out by a peer student taking the role of the teacher in the similar manner as the original lesson has been taught. Although the teacher may select manually the slower students and those who can perform better in their practice or tests to conduct the tutorial session as a buddy teacher, it will save the teacher much time if the system can automatically appoint a student tutor and identify the students in need of extra lessons.

It is therefore obvious that there is a need for a computer-aided method for guided teaching to address some or all of the issues described above.

### SUMMARY OF THE INVENTION

The object of the present invention is to provide a computer-aided method for guided teaching, wherein teaching materials of various styles and stimuli are used.

In accordance with the present invention, there is provided a computer aided method for guided teaching of vocabulary between a teacher and a class of students in a guided teaching session, having at least one teacher workstation, at least one student display, and a central processing unit, comprising the steps of:
(a) presenting a question to the student at a student display;
(b) receiving input from the teacher at the teacher workstation for the teacher to give further information related to the question;
(c) presenting information using at least one of a plurality of styles and stimuli corresponding to the input from the teacher on the student display;
(d) receiving answer from the teacher at the teacher workstation, wherein the answer is received by the teacher from the student;
(e) determining whether the answer is correct; and (f) presenting feedback to the answer at student display.

The teacher may further input teaching notes at the teacher workstation for displaying to the students or to be shared among other teachers.

The present invention provides significant advantages over the conventional teaching method, for example, the teacher may provide guidance to the student on the student display, using various styles and stimuli, such as text, sound, voice, audio, graphics, pictures, photographs, animation, or video, in a guided teaching approach. Such guidance is especially effective when the teacher uses multiple choice questions to interact with the students in the teaching process. The students will not be frustrated after selecting a wrong answer if the teacher can guide the student to reach the correct answer afterwards.

In one embodiment of the present invention, after presenting the question to the student on the student display, the teacher may present additional information related to the question on the student display to guide the student to reach the right answer.

In another embodiment of the present invention, the additional information may be presented in various styles and stimuli, such as text, sound, voice, audio, graphics, pictures, photographs, animation, or video to arouse the interests of the students.

In another embodiment of the present invention, the teacher may save and share notes with other teachers teaching the same course.

In another embodiment of the present invention, a system is provided to ensure the teaching materials and hints delivered to the students by various teachers are consistent.

In another embodiment of the present invention, the teacher may adjust the teaching materials preset in the system.

In another embodiment of the present invention, a system is provided to automatically adjust the level of difficulty of the questions according to the performance of the students in the individual practice sessions.

In another embodiment of the present invention, a system is provided to allow another person, for example a replacement teacher or a student, to take up the role of the original teacher without much deviation from the original teaching style.

In another embodiment of the present invention, a system is provided to assign the appropriate students to conduct or to take extra tutorial session, whereby a student taking the role of the teacher in the same manner as the original lesson has been taught.

In another embodiment of the present invention, the key information in the teaching process is recorded for future review of the course materials.

### BRIEF DESCRIPTION OF DRAWINGS

The above and other aspects, features, and advantages of the present invention will become more apparent upon consideration of the following detailed description of preferred embodiments, taken in conjunction with the accompanying drawing figures, wherein:—

FIG. 1 is a flowchart which illustrates the log-in process in accordance with an embodiment of the present invention;

FIG. 2 is a flowchart which illustrates the retrieval of teaching materials in accordance with an embodiment of the present invention;

FIGS. 3a-3c are a set of flowcharts which illustrates the method in accordance with an embodiment of the present invention;

FIG. 4a shows the screen capture on the teacher workstation in accordance with an embodiment of the present invention;

FIGS. 4b and 4c show the screen capture on the student display in accordance with an embodiment of the present invention;

FIG. 4d shows the screen capture in accordance with an embodiment of the present invention;

FIG. 5a shows the screen capture on the teacher workstation in accordance with an embodiment of the present invention;

FIG. 5b shows the screen capture on the student display in accordance with an embodiment of the present invention;

FIG. 5c shows the screen capture in accordance with an embodiment of the present invention;

FIG. 5d shows the screen capture in accordance with an embodiment of the present invention;

FIG. 6 illustrates a network arrangement in accordance with an embodiment of the present invention;

FIG. 7 is a flowchart which illustrates an individual practice session in accordance with an embodiment of the present invention;

FIG. 8 shows the screen capture which illustrates the recording of the score of the students in the individual practice session in accordance with an embodiment of the present invention; and

FIG. 9 is a flowchart which illustrates the adaptive teaching in accordance with an embodiment of the present invention

### DETAILED DESCRIPTION OF THE INVENTION

### Log-in

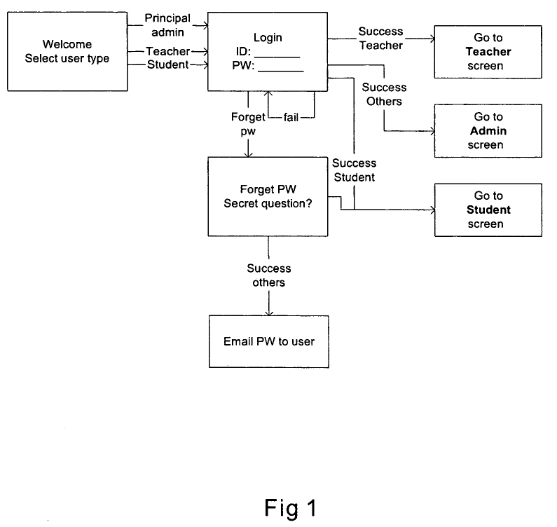

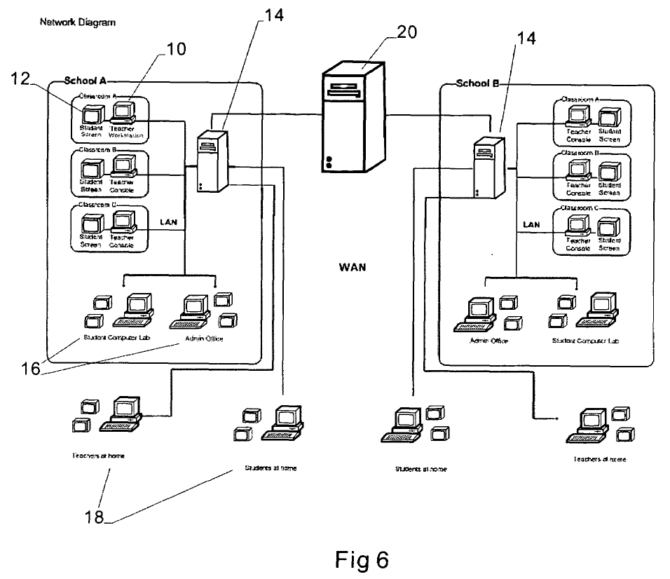

As illustrated in FIGS. 1 and 6, a preferred embodiment of the present invention allows the teacher to log-in at a teacher workstation [10] to record the teacher's attendance for a guided teaching session. The teacher may also log-in the students who are present for the student attendance record. The teacher workstation [10] may, for example, be a notebook computer or a terminal, with a display device and a keyboard.

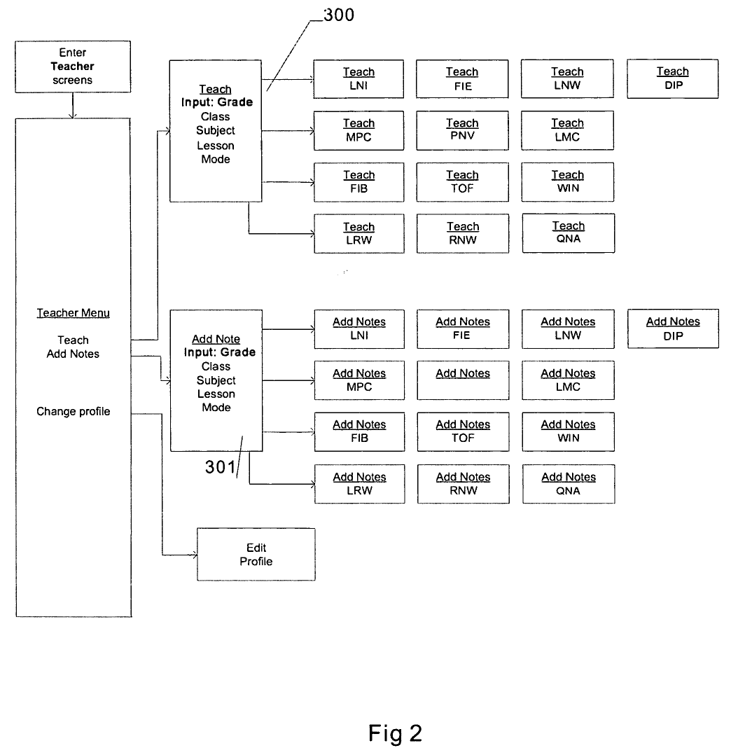

As illustrated in FIG. 2, in step [300], the teacher inputs the information related to the guided teaching session, for example, the grade, the class, the subject, the lesson and the teaching mode for retrieval of the relevant teaching materials. The teaching mode defines the type of question used in teaching language to be presented to the students. Some examples of the teaching mode are:

| Teaching mode | Description of question type |
|---|---|
| LNI | Listen to English and/or Mandarin description and |
| | identify a related picture |
| LNW | Look at an object and write |
| MPC | Multiple choice |
| FIE | Fill in the essay |
| LMC | Listen to Chinese or another language and choose |
| | an answer in English |
| FIB | Fill in the blank |
| TOF | True or false |
| LRW | Link the right word |
| RNW | Read and write |
| WIN | Arrange pictures in a logical manner based on hints given |
| QNA | Question and answer |
| DIP | Definition of idiomatic phrase |
| PNV | Passage and vocabulary |

Various teaching modes are provided so that the same set of materials used in teaching a language can be applied in different teaching modes according to the level of students and the desired outcome.

### A Preferred Embodiment—DIP Mode

A preferred embodiment for teaching idiomatic English, also known as phrasal verbs in a guided teaching session, is used to illustrate the present invention. A phrasal verb contains a verb and a preposition, which carries a specific meaning only when the two parts are combined and used together.

Regardless of the subject and the teaching mode chosen, the guided teaching session may be divided into the following major steps:

1. Show and ask;

2. Show more and prompt;

3. Show and challenge; and

4. Show and instruct.

### Show and Ask

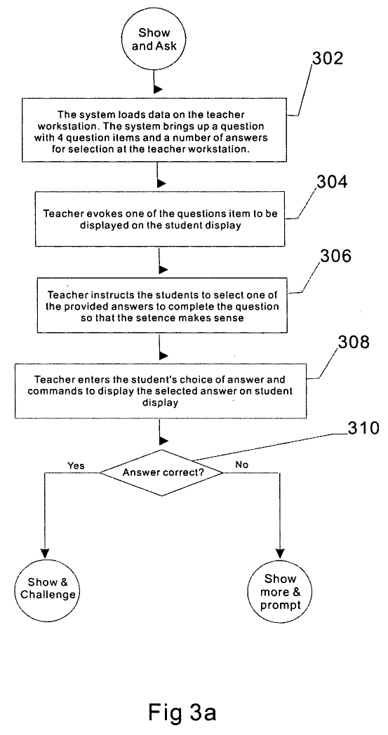

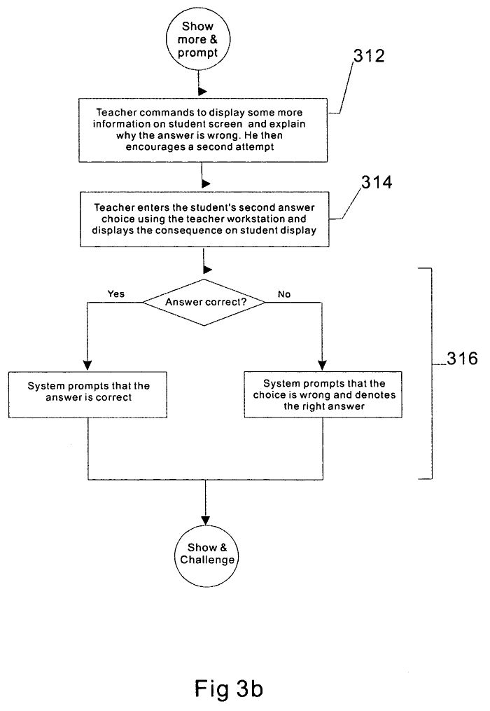

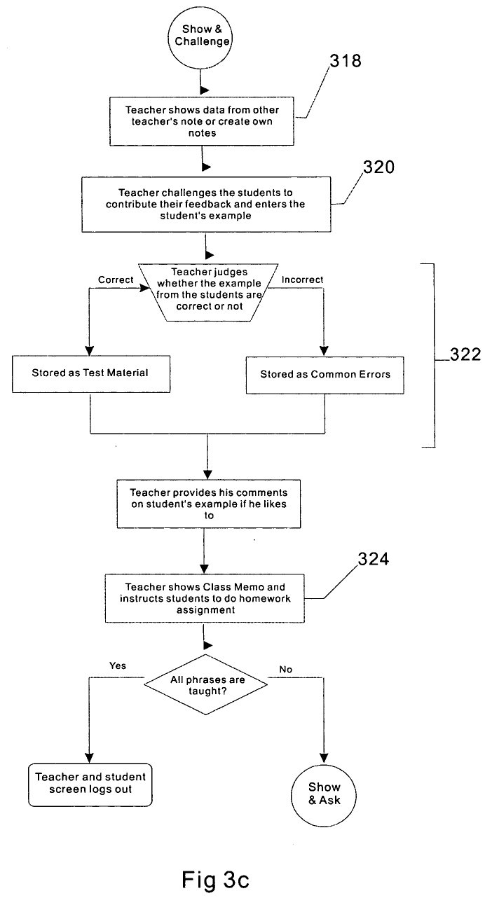

In a preferred embodiment, as illustrated in FIGS. 3a, 4a and 6, in step [302], a question set [110] containing four question items and a number of answers [112] for selection are displayed at the teacher workstation [10]. The question set [110] are a number of question items being sentences each containing a verb and a following blank for student to insert an appropriate preposition. The students are given a list of answers [112] to select from. In step [304], the teacher selects a question item among the question set [110] to work on and to be presented on a student display [12]. By way of example, the question item [114] is selected.

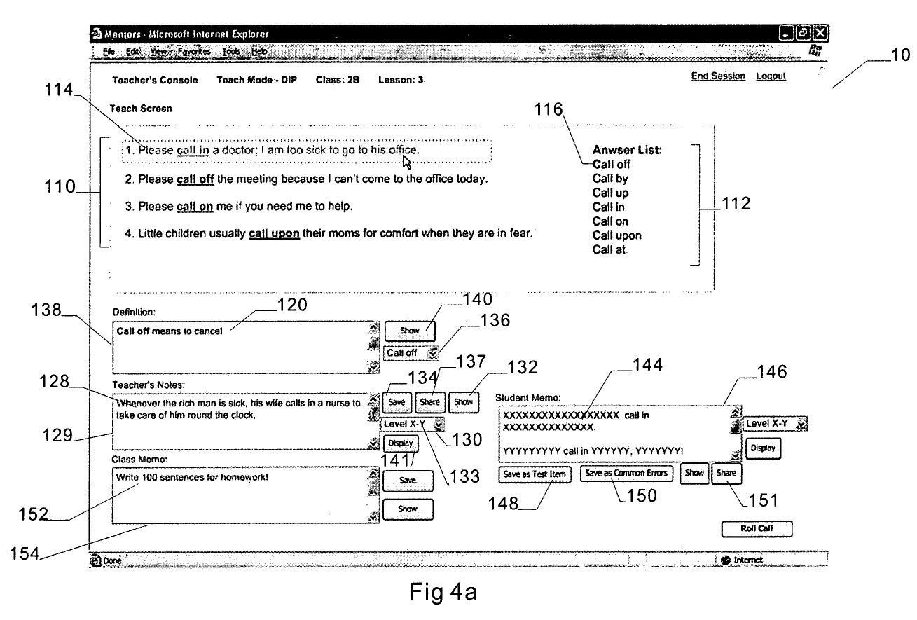

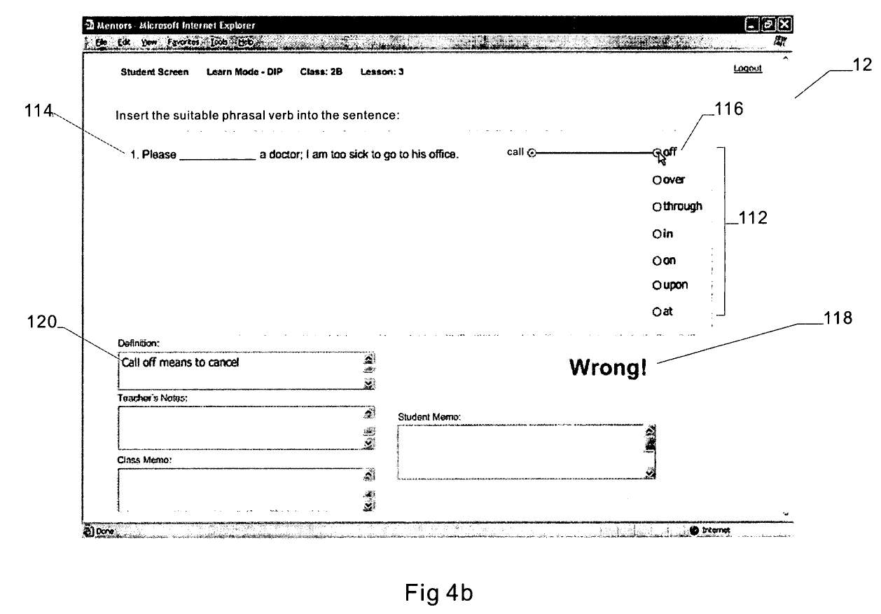

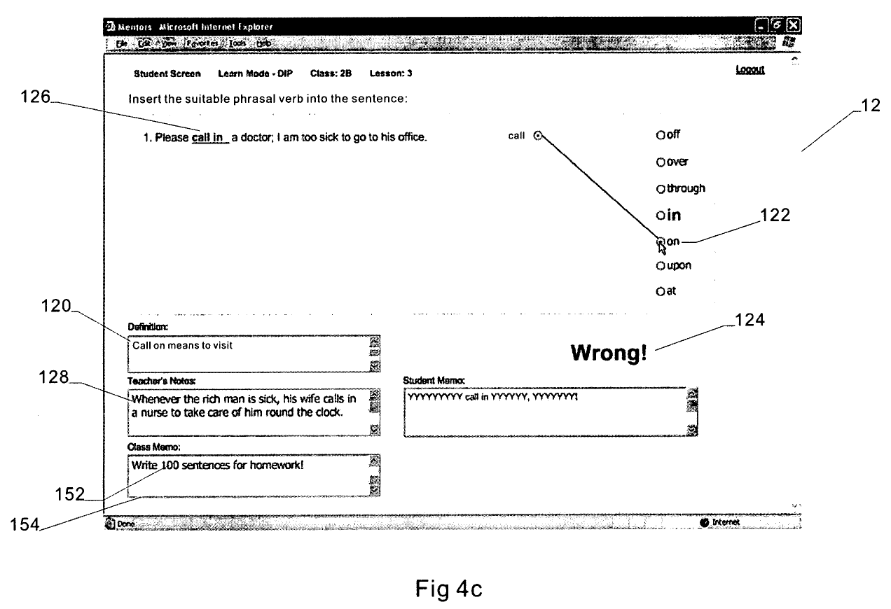

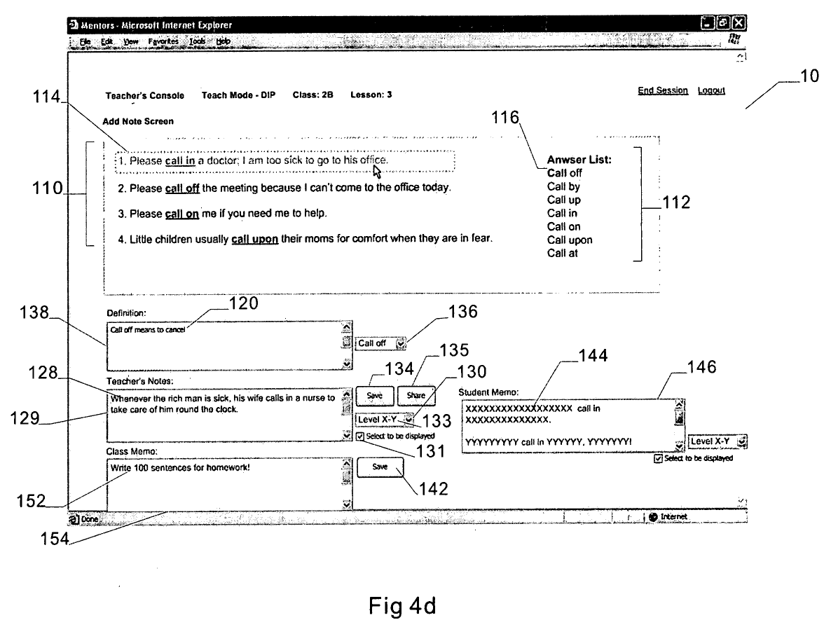

The student display [12] may, for example, be a projector and screen for displaying to the whole class of students, or an individual monitor for each student. FIG. 4b shows the screen displaying the question item [114] selected by the teacher and the answers [112] available for selection.

In step [306], the teacher discusses and interacts with the students until he has obtained one answer from the students to be entered. In step [308], the teacher clicks on the answer [116] selected by the students on the teacher workstation [10]. The answer [116] selected by the student will be shown on the student display [12]. In this preferred embodiment, a line is connected from the question to the selected answer [116] to show the students the selected answer.

In step [310], a central processing unit [14] performs the comparison of the selected answer [116] with the correct answer. A feedback [118] is displayed on the student display [12]. The feedback [118] may be in the form of text, graphics or animation, or combined with sound effect, for indicating whether the selected answer [116] is correct or not.

### Show More and Prompt

As illustrated in FIGS. 3b and 4b, in step [312], if the selected answer [116] is wrong, the teacher may explain why the answer is wrong to the students by giving further information [120] related to the question [114]. The information [120] is provided to guide the students to have a second attempt to get to the correct answer, which can be in the form of various styles and stimuli, such as text, sound, voice, audio, graphics, pictures, photographs, animation, video, or a combination of the above, to make the teaching process more appealing to the students.

By way of example, the information [120] is the definitions of the phrasal verbs given as the answers [112] in text form. The teacher may select the phrasal verb of which the definition is to be shown from box [136] at the teacher workstation [10]. The information [120] is shown in box [138] on the teacher workstation [10]. The teacher may click Show button [140] to display the information [120] at the student display [12]. By way of example, the information [120] may also be provided in an audio form, that is, by executing an audio file containing the syllabus of the definition. Such audio file may also contain a version in the native language of the student to enable the student to understand the information [120] more easily. The teacher may present the definitions of some or all the phrasal verbs in the answers [112] one by one. After learning the definitions of the phrasal verbs, the students can easily select the right answer. The provision of the information [120] allows the students to make an educated selection rather than a wild guess.

As illustrated in FIG. 4c, in step [314], the teacher leads a brainstorming discussion with the students to obtain an answer [122] from the students and inputs the answer at the teacher workstation [10]. The student display [12] shows the answer [122] and the feedback [124]. The teacher may choose to present the correct answer [126] as shown in step [316] or to repeat step [312] to give further information [120] to the students.

### Show and Challenge

As illustrated in FIGS. 3c and 4a, 4c, after reaching the correct answer [126], in step [318], the teacher may review the teaching notes [128] with respect to the question set [110] of his own or other teachers stored in the central processing unit [14] by selecting a level indicator [133] in box [130]. The teaching notes [128] may be examples created by the teacher (see Review before class below) or used by other teachers to illustrate the correct answer [126]. The teaching notes [128] are grouped with respect to each specific question set and are automatically assigned a level indicator [133] on the level of difficulty according to the class for which the teacher has saved the teaching notes [128] for. By clicking the “Show” button [132], the teaching notes [128] may be shown at the student display [12].

The teacher may also create his own teaching notes [128] in class in box [129] and show the teaching notes [128] at the student display [12] by clicking the Show button [132]. The teaching notes [128] will be saved for future reference. The teacher may save the teaching notes [128] without showing on the student display [12] by clicking the Save button [134]. If the teacher wants to make the teaching notes [128] available for other teachers, he may click the Share button [137] to authorize the sharing.

In step [320], the teacher guides the students to create their own sentences using the phrasal verb taught in the question [114]. The teacher may enter the sentences [144] created by the students as reference notes in box [146] at the teacher workstation [10]. In step [322], the teacher may discuss with the students about the created sentence [144] and give his comments. If the created sentence [144] is a good example of the use of the phrasal verb, the teacher may save the sentence for use in a quiz or a test by clicking Save as Test Item button [148]. If the created sentence [144] seems to be a common error made by many students, the teacher may save the sentence for future reference by clicking Save as Common Error button [150]. If the teacher wants to make the sentences [144] available for other teachers, he may click the Share button [151] to authorize the sharing.

### Show and Instruct

The teacher may proceed to the next question by repeating from step [304]. In the course of teaching, the teacher may provide instructions to the students on the homework assignments. In step [324], the teacher may enter the instructions [152] in box [154] at the teacher workstation [10] and click Show button to show the instructions [152] at the student display [12].

### Review Before Class

As shown in FIG. 4d, the teacher may preview the teaching materials, for example the question set [110] and the answers [112] for selection before conducting the teaching session. The teacher can therefore become acquainted with the teaching materials before class.

The teacher may also create some examples of sentences to illustrate the correct answer. Such examples may be saved as teaching notes [128] in box [129] by clicking Save button [134] for the teacher's own retrieval or by clicking Share button [135] for sharing with other teachers. The teaching notes [128] are saved with respect to each question set and are assigned a level indicator [133] according to the level of the class the teaching notes [128] has been created for. The teacher may also review the teaching notes [128] of other teachers by selecting the level indicator [133] at box [130]. The teacher may pre-select the teaching notes [128] of the teachers to be shown in the class by checking the box [131]. The pre-selected teaching notes may be recalled in class by clicking Display button [141] as shown in FIG. 4a.

In order to facilitate the teacher in viewing the saved teaching notes of other teachers, the central processing unit [14] may keep track of the number of times the teaching notes have been selected to show to the students, and automatically delete the teaching notes below a predetermined selection rate in a period of time.

The teacher may also save some instructions to be presented in class to students by inputting in box [154] and clicking Save button [142].

### Another Embodiment—FIB Mode

In addition to the above embodiment for teaching phrasal verbs, the present invention is also applicable to other teaching mode. In another preferred embodiment for teaching vocabulary, the present invention is used in providing fill-in-the-blank questions using the FIB mode. The students are given a selection of words, such as verbs or nouns, which usually carry clear meanings by themselves. The teacher is allowed to provide additional hint or information to the students for reaching the correct answer.

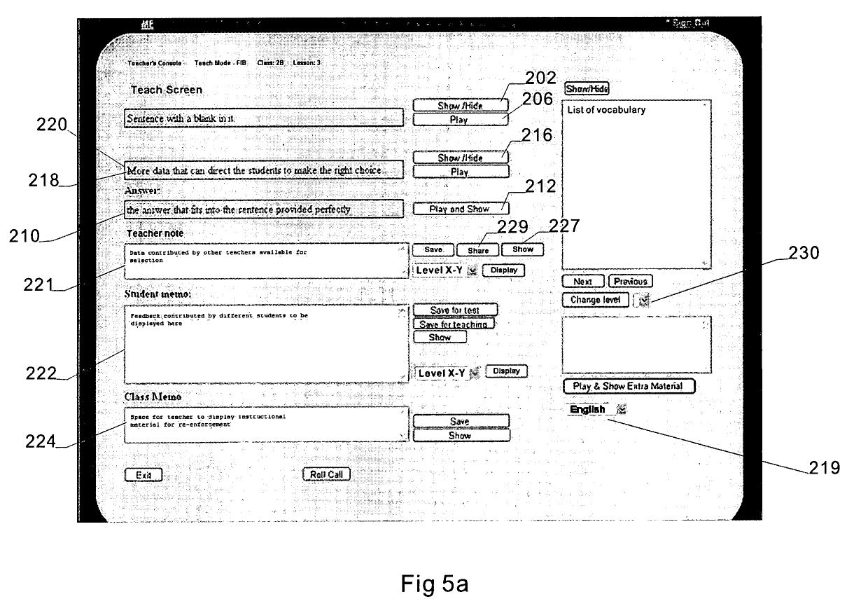

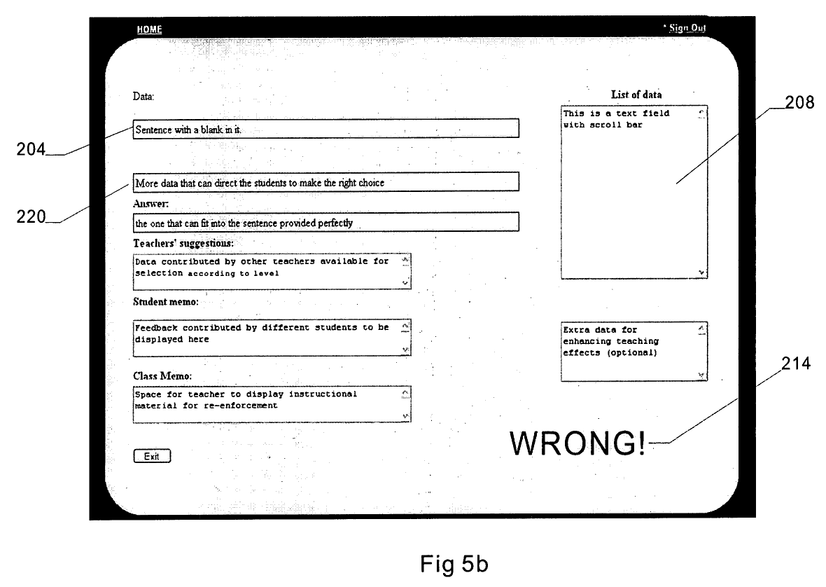

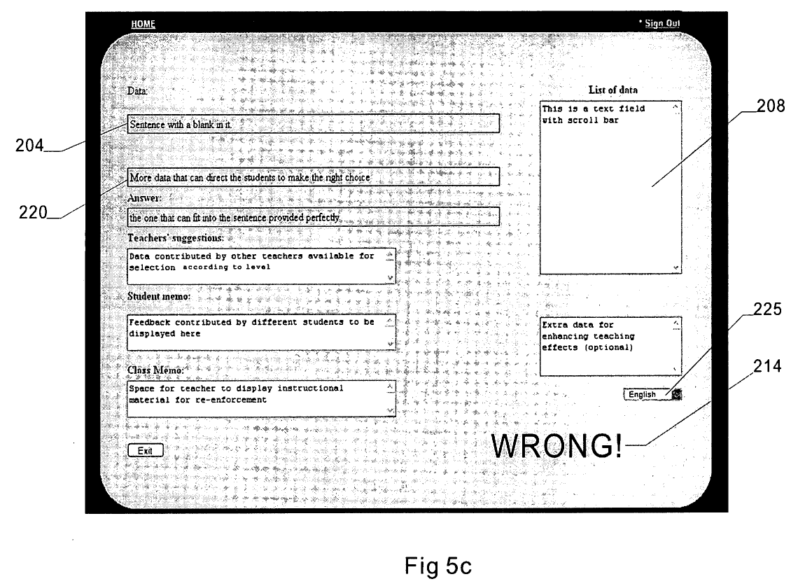

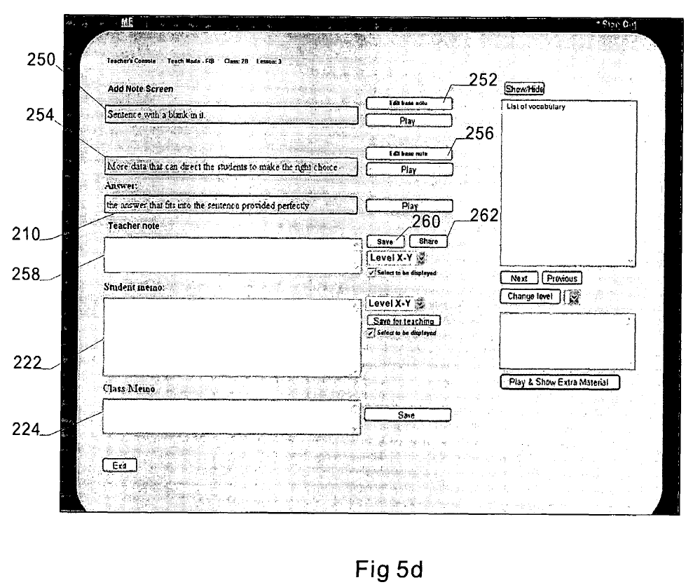

As illustrated in FIGS. 5a and 5b, the teacher may click button “Show/Hide” [202] to present the question at a box [204] on the student display [12]. The teacher may also click button “Play” [206] to play a pre-recorded audio form of the question. A list of answers containing one correct answer is provided in box [208] on the student display [12]. The teacher may enter an answer collected from the students in box [210] and click the button “Play and Show” [212]. A box [214] will show whether the answer entered is correct. If the answer is wrong, the teacher may further click button “Show/Hide” [216] to show the additional information in box [218] on the student display [12] in box [220] which will assist the students in reaching the correct answer. By way of example, the information may be the definition of a word in box [208]. The teacher is allowed to modify the information in box [218] generated in the teacher workstation [10] if appropriate. The button “Show/Hide” [216] is disabled before the teacher enters the answer collected from the student.

The teacher may review the teaching notes of other teachers or to input his own teaching notes in box [221]. The teacher may select to show the teaching notes on the student display [12] by clicking the Show button [227]. The teacher may authorize the sharing of his teaching notes with other teachers by clicking the Share button [229]. Further, a box [222] is provided for entering and saving the examples provided by the students and a box [224] is provided for entering the instructions for the students, for example, the homework assignment.

### Multi-Lingual Display

The teacher may select the language of the student display [12] according to the need of the students by selecting a language in box [219]. By way of example, English is used as the language of the student display [12].

There may be a mix of students from different countries in the class. Each student may prefer to have the student display [12] in his own language. In another preferred embodiment as shown in FIG. 5c, each student is provided with his own student display [12] including an input device, for example a workstation. The student may input the selected language in box [225] in his workstation. The appropriate language for selection may be provided in box [225] according to the profile of the student stored in a database which can be accessed after the log-in of the student.

### Editing Materials

In this preferred embodiment, the teacher may easily edit the teaching materials, such as the question, the supplemental information and the teaching notes before class. As illustrated in FIG. 2, in step [301], the teacher may retrieve the teaching materials for editing. The teacher may edit the questions or prepare his own teaching notes on a page as illustrated in FIG. 5d. The teacher may edit the question in box [250] and click button “Edit base note” [252] to save the amendment. The teacher may also edit the supplemental information in box [254] and click button “Edit base note” [256] to save the amendment. The teacher may prepare the teaching notes in box [258] and save the teaching notes by clicking Save button [260]. The teacher may further authorize the sharing of his teaching notes with other teachers by clicking the Share button [262].

### Networking

As illustrated in FIG. 6, the teacher workstation [10] and the student displays [12] are connected to the central processing unit [14], which may be, for example, a personal computer or a server of the school. The server of the school may be connected to other computers [16], for example, in a student computer laboratory, or in the teacher office. The teachers and the students may also use their own computers [18] at home to access the central processing unit [14] via the Internet. The central processing unit [14] of a school may be connected with the central processing unit [14] of another school to share the teaching materials. A global server [20] may contain the most updated software patch and teaching materials. The central processing units [14] may be connected to the global server [20] for regular downloading of the updated software patch and teaching materials.

### Individual Practice Session

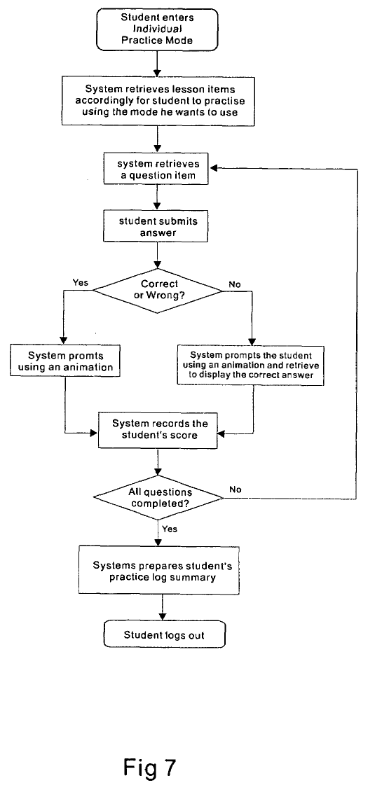

In addition to classroom teaching, the students may be requested to do homework assignment by taking individual practice session. In an individual practice sessions, by way of example as illustrated in FIG. 7, each student is given multiple choice questions related to the teaching materials. The students may access the questions in a computer laboratory in school or at home via the Internet.

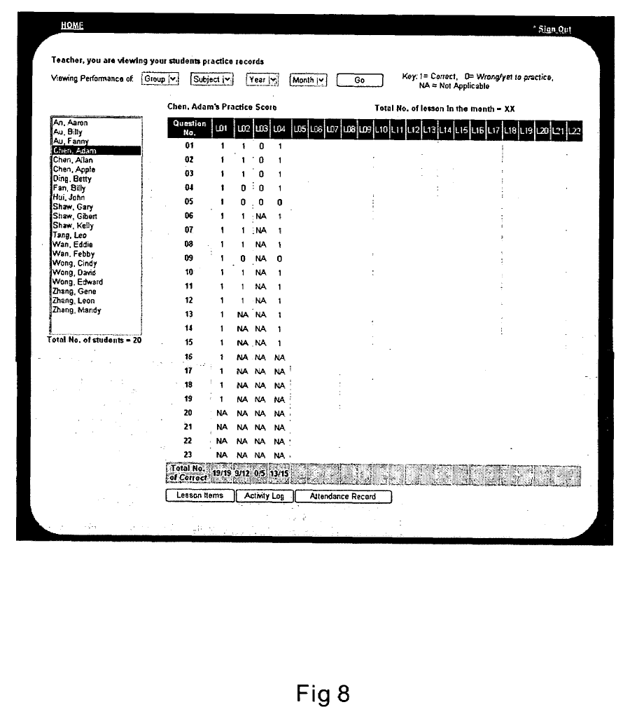

As illustrated in FIG. 8, the scores of the students are recorded by the central processing unit [14]. By way of example, the student receives 1 score for each correct answer. The average score of all the students in the class therefore serves as an indicator on how familiar the class is with the teaching materials.

### Adaptive Teaching

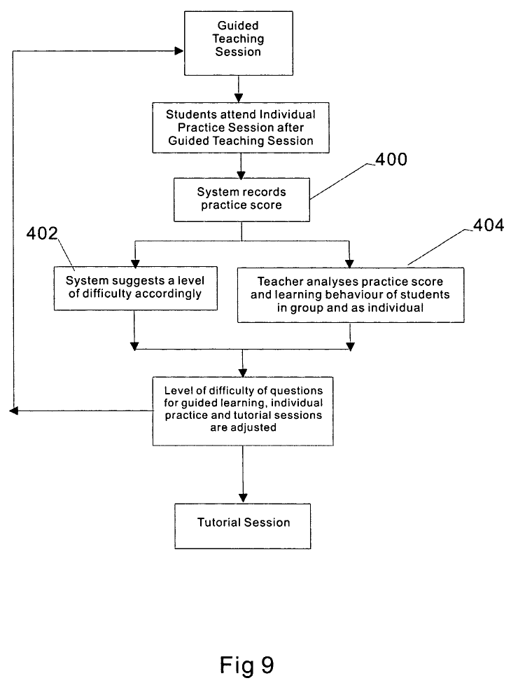

In a preferred embodiment as illustrated in FIG. 9, in step [400], the central processor unit [14] records the score of the students in attending individual practice sessions. The central processor unit [14] then suggests the level of difficulty to be adopted for the guided teaching session, the individual practice session and the tutorial session (which will be described below) in step [402], according to a pre-determined table matching the average score to the level of difficulty. The teacher may determine the level of difficulty on his own by analyzing the recorded student score as shown in step [404].

By way of example, in providing fill-in-the-blank questions as illustrated in FIG. 5b, the level of difficulty in providing fill-in-the-blank questions in a guided teaching session may be adjusted by increasing or reducing the number of answers provided in box [208]. The more answers available to the students for selection, the more words the students need to know of the meaning before they can get at the right answer. As such, the level of difficulty increases with the number of answers for selection. The system may automatically generate the number of answers for selection according to the average score of the students in the individual practice session. The teacher may further adjust the number of answers if necessary according to the performance of the students by entering the desired number of answers in box [230] as shown in FIG. 5a.

### Tutorial Session

Some students may be required to take extra tutorial session to be conducted by some advanced student in the class. The advanced student may take the role of the teacher and host a guided teaching session for his classmates using the present invention. The students who need to take the extra tutorial session may be those who skip the class or those who score low in the individual practice session. In another preferred embodiment, the central processing unit [14] may assign the students to conduct or to take the extra tutorial session according to the attendance record of the students and their score recorded in the individual practice session. The teacher may preset a practice score and an attendance level to be the benchmark for a student to be qualified to be the teacher in the tutorial session or to be required to take the tutorial session. The central processing unit [14] may match the score of the students in the individual practice session and the attendance record to the benchmark score and attendance level to suggest to the teacher the students who may qualify as a teacher in the tutorial session or who may be required to take the tutorial session. The teacher may also assign students to the tutorial session according to his own observation.

### Saving Key Data

The central processing unit [14] will save the key data in the course of the guided teaching session, such as, the time required for the students to correctly answer a question, the number of times the teacher gives additional information on the student display for the students to select the correct answer and the number of wrong answers made by the students before reaching the correct answer. Such data may be used to review the course and to design better teaching materials, such as the questions, answers and additional information, to make the teaching more effective.

### Database Structure

The following databases are used as part of the method and system of the present invention.

TABLE 1
Login Table

| Name | Description |
|---|---|
| LogInID | Unique ID for login |
| UserName | User Name for login |
| Password | Password |
| UserType | Type of users (Teacher/Admin/Students) |

Table 1 holds the information for login. When a user login as illustrated in FIG. 1, he will select the user type and input his username and password. The system will then obtain the login ID from the Login Table and check whether the user is authorized to login. If the login is successful, the system will load the corresponding screen according to the user type.

TABLE 2
Lessons Table

| Name | Description |
|---|---|
| LessonID | Unique ID for lesson |
| ModeID | Unique ID for teaching mode |
| ClassID | Unique ID for class |
| Level | Level of the lessons |

Each lesson contains the teaching materials of the guided teaching system or the tutorial session, for example, the questions, the answers for selection, the additional information in various styles and stimuli, such as text, sound, voice, audio, graphics, pictures, photographs, animation, or video. Table 2 holds a list of the Lesson ID.

After the teacher has input the required information such as the class and the level of lessons and the teaching mode such as FIB, MPC, TOF and LRW as illustrated in FIG. 2, the system will select the suitable Lesson ID from the Lessons Table and load the corresponding teaching materials to the teacher workstation [10] and the student display [12].

TABLE 3
Mode Table

| Name | Description |
|---|---|
| ModeID | Unique ID for teaching mode |
| Name | Name of teaching mode |
| Description | Description of teaching mode |

Table 3 stores a list of the teaching mode. This table relates the teaching mode such as FIB, MPC, TOF and LRW and the description of the teaching mode to the Mode ID.

TABLE 4
LessonItemID Table

| Name | Description |
|---|---|
| LessonItemID | Unique ID for lesson Item |
| LessonID | Unique ID for lesson |

Each Lesson Item contains the teaching materials of each question. Table 4 contains the Lesson Item ID and the Lesson ID. After selecting a Lesson by the teacher, the system will select the suitable Lesson Item ID from the Lesson Item ID Table and load the corresponding teaching materials to the teacher workstation [10] and the student display [12] according to the Lesson Item ID.

TABLE 5
Phrase Table

| Name | Description |
|---|---|
| Phrase ID | Unique ID for the phrase |
| Phrase | The question phrase |
| Definition | definition of the phrase |

Table 5 contains a part of each question, known as the Phrase, to be combined with the data from other tables, such as the vocabulary, which may be the answers for selection, and the digital image to form a complete question. The Phrase of each question is loaded according to the Phrase ID.

TABLE 6
Vocabulary Table

| Name | Description |
|---|---|
| VocabID | Unique ID for vocabulary |
| Vocab | Vocabulary |
| Definition | Definition of vocabulary |
| DefinitionAudio | Definition of vocabulary in audio format |
| Level | The level of difficulty of the vocabulary |

Table 6 contains the vocabulary, which may be the answers for selection in a question. The vocabulary is to be combined with the data from other tables such as the Phrase and the digital image to form a complete question. The audio recording of the pronunciation of the vocabulary and the level of difficulty of the vocabulary are also included in this table. In the MPC mode and the FIB mode, the level of difficulty for the vocabulary indicates the number of answers to be available for selection.

TABLE 7
Digital Image Table

| Name | Description |
|---|---|
| DigitalImageID | Unique ID for digital image |
| Type | Type of the digital image |
| DIPath | Path of the digital image |
| Program | Program tool for loading the digital image |

Table 7 contains the ID for identifying the digital image related to each question. The digital image combines the data from other tables, such as the Phrase and the vocabulary, which may be the answers for selection, to form a complete question. This table also contains the program paths of the digital images and the execution link of the program tool for loading the digital images.

TABLE 8
Classes Table

| Name | Description |
|---|---|
| ClassID | Unique ID for class |
| SubjectID | Unique ID for subject |
| ClassName | Name of class |
| SectionNbr | Section number |
| Term | Term number |
| SchoolYear | School Year |

Table 8 contains the information of each class. The system may obtain the name, the section number, the term, the school year and other information of each class by the Class ID.

TABLE 9
Student Table

| Name | Description |
|---|---|
| StudentID | Unique ID for student |
| ClassName | Name of class |
| PersonalID | Personal ID for student |
| FirstName | First name of student |
| MiddleName | Middle name of student |
| LastName | Last name of student |
| Nationality | Nationality of student |

Table 9 contains the information of the students. The system may retrieve the information of the student, such as, the name of class, the student personal ID number, the first name, middle name and last name and the nationality of the student by the Student ID. The additional language of the student display for selection may be set according to the nationality of the student.

TABLE 10
Student Test Summary Log Table for the Individual Practice Session

| Name | Description |
|---|---|
| TSLID | Unique ID for the Test Summary Log |
| StudentID | Unique ID for student |
| TSLScore | Score of the Test Summary Log |
| TSLRemarks | Remark for the Test Summary Log |
| TSLCorrect | Number of correctly answered questions in a test |
| TSLWrong | Number of wrongly answered questions in a test |

Table 10 contains the students' test results in the Individual Practice Sessions. The table contains the score, the number of correctly and wrongly answered questions, and the remarks of the test. The score will be referred to in adjusting the level of difficulty of questions for adaptive teaching, and in selecting the students to participate in the Tutorial Session. The test results may be retrieved by the Student ID.

TABLE 11
Teacher Table

| Name | Description |
|---|---|
| Teacher ID | Unique ID for teacher |
| PersonalID | Personal ID for student |
| FirstName | First name of student |
| MiddleName | Middle name of student |
| LastName | Last name of student |
| Employment Date | Date of employment |

Table 11 contains the information of the teachers. The system may retrieve the information of the teachers, such as, the personal ID number, the first name, middle name and last name of the teacher by the Teacher ID.

TABLE 12
Teaching Notes Table

| Name | Description |
|---|---|
| NoteID | Unique ID for the teaching notes |
| ContentType | Type of teaching content of the teaching notes |
| Content ID | Unique ID of the ContentType |
| TeacherID | Unique ID of the teacher to identify the author |
| Date | The creation date of the teaching notes |
| UsageCount | The number of times the teaching notes was used |
| | in a lesson |
| Note | Content of the teaching notes |
| Note Level | The level of difficulty or grade level of the |
| | teaching notes |

Table 12 contains the information of the teaching notes. The system may retrieve the content of the teaching notes, content type, level, author, creation date and usage count by the NoteID. The Date and UsageCount keep track of the number of times the teaching notes have been selected to show to the students, and the teaching notes below a predetermined selection rate in a period of time will be automatically deleted.

There are also databases containing other information, for example, the instructions to the students, the examples from the students to be used in quiz or test, the common error made by the students for future reference, and the question in other languages, which are used in the guided teaching session as described in the disclosed embodiments.

In addition to be used in class teaching, the present invention is also applicable in one-to-one teaching and long distance learning via the Internet. The present invention is not limited to teaching in school, but is also applicable to training in various aspects.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

What is claimed is:

1. A computer-aided method for guided teaching of language between a teacher and at least one student having at least one teacher workstation, at least one student display, and a central processing unit, comprising the steps of:
(a) presenting a question to the student at said student display;
(b) receiving input from the teacher at said teacher workstation for the teacher to give further information related to said question;
(c) presenting information using at least one of a plurality of styles and stimuli corresponding to said input on said student display;
(d) receiving answer from the teacher at said teacher workstation, wherein said answer is received by the teacher from the student;
(e) determining whether said answer is correct;
(f) presenting feedback to said answer at said student display;
wherein said central processing unit is connected to said teacher workstation and said student display, such that the teacher provides guidance to the student on said student display in a guided teaching session.

2. The computer-aided method as recited in claim 1, wherein said plurality of styles and stimuli comprises: text, sound, voice, audio, graphics, pictures, photographs, animation, and video.

3. The computer-aided method as recited in claim 1, wherein said question comprises a plurality of answers for selection.

4. The computer-aided method as recited in claim 1, further comprises the step of receiving input of notes from the teacher at said teacher workstation.

5. The computer-aided method as recited in claim 4, further comprises the step of presenting said notes on said student display.

6. The computer-aided method as recited in claim 4, further comprises the step of receiving an instruction from the teacher on the authorization for presenting said notes at said student display and controlling the presenting of said notes according to said instruction.

7. The computer-aided method as recited in claim 4, further comprises the step of storing said notes in said central processing unit.

8. The computer-aided method as recited in claim 7, wherein said notes are shared by said teacher workstations.

9. The computer-aided method as recited in claim 4, further comprises the step of receiving an instruction from the teacher on the authorization for sharing said notes by said teacher workstations and controlling the sharing of said notes according to said instruction.

10. The computer-aided method as recited in claim 7, wherein a level indicator is assigned to said notes for identifying the level of students applicable to said notes during retrieval of said notes.

11. The computer-aided method as recited in claim 2, wherein the student is engaged in individual practice session and the performance of the student in said individual practice session is recorded by said central processing unit.

12. The computer-aided method as recited in claim 11, wherein said central processing unit formulates said question according to an analysis of said performance.

13. The computer-aided method as recited in claim 11, wherein said central processing unit stores the attendance record of the student in said guided teaching session.

14. The computer-aided method as recited in claim 13, wherein at least one student is-selected by said central processing unit to engage in an extra tutorial session according to said attendance record and said performance, wherein one of said students taking the role of a teacher in said tutorial session.

15. The computer-aided method as recited in claim 1, wherein said central processing unit records key data for future revision of said question and said information, comprising at least one of:
the time between presenting said question and receiving said answer being correct;
the number of said input from the teacher between presenting said question and receiving said answer being correct; and
the number of said answers received from the teacher for each said question.

16. The computer-aided method as recited in claim 1, wherein said question can be edited by the teacher.

17. The computer-aided method as recited in claim 1, wherein said information can be edited by the teacher.

18. The computer-aided method as recited in claim 4, wherein said notes comprises at least one of:
idea from the teacher related to said question,
illustrative example from the teacher related to said question,
idea from the student related to said question,
illustrative example from the student related to said question, and
instruction from the teacher to the student.

19. The computer-aided method as recited in claim 1, wherein one of a plurality of languages can be selected to be used on said student display.

20. The computer-aided method as recited in claim 19, further comprises at least one student input device for receiving from the student the selection of language to be used on said student display.

21. A computer-aided system for guided teaching of vocabulary between a teacher and at least one student comprising:
a central processing unit, having memory means, for storing questions to be presented to said student;
at least one student display associated with said central processing unit for presenting said question to the student;
at least one teacher workstation associated with said central processing unit, having input means for receiving input from the teacher to give further information related to said question and for receiving answer from the teacher, wherein said answer is received by the teacher from the student;
communication means between said central processing unit and said teacher workstation and between said central processing unit and said student display;
wherein said central processing unit having processor means for determining whether said answer is correct and said student display present feedback to said answer;
such that the teacher provides guidance to the student on said student display.

22. The computer-aided system as recited in claim 21, wherein said plurality of styles and stimuli comprises: text, sound, voice, audio, graphics, pictures, photographs, animation, and video.

23. The computer-aided system as recited in claim 21, wherein said input means receive input of notes from the teacher.

24. The computer-aided system as recited in claim 23, wherein said student display presents said notes to the student.

25. The computer-aided system as recited in claim 23, wherein said central processing unit stores said notes.

26. The computer-aided method as recited in claim 25, wherein a level indicator is assigned to said notes for identifying the level of the students applicable to said notes during retrieval of said notes.

27. The computer-aided system as recited in claim 25, wherein said notes are shared by said teaching workstations.

28. The computer-aided system as recited in claim 23, wherein said input means receive an instruction from the teacher on the authorization for presenting said notes on said student display; said central processing unit controls the presenting of said notes according to said instruction.

29. The computer-aided system as recited in claim 23, wherein said input means receive an instruction from the teacher on the authorization for sharing said notes by said teacher workstations; said central processing unit controls the sharing of said notes according to said instruction.

30. The computer-aided system as recited in claim 25, wherein a level indicator is assigned to said notes for identifying the level of students applicable to said notes during retrieval of said notes.

31. The computer-aided system as recited in claim 21 wherein said central processing unit records the performance of the student engaged in individual practice session.

32. The computer-aided system as recited in claim 31, wherein said central processing unit formulates said question according to an analysis of said performance.

33. The computer-aided system as recited in claim 31, wherein said central processing unit stores the attendance record of the student in said guided teaching session.

34. The computer-aided system as recited in claim 33, wherein said central processing unit selects at least one student to engage in an extra tutorial session according to said attendance record and said performance, wherein one of said students taking the role of a teacher in said tutorial session.

35. The computer-aided method as recited in claim 21, wherein one of a plurality of languages can be selected to be used on said student display.

36. The computer-aided method as recited in claim 35, further comprises at least one student input device for receiving from the student the selection of language to be used on said student display.

37. The computer-aided method as recited in claim 23, wherein said notes comprises at least one of:
idea from the teacher related to said question,
illustrative example from the teacher related to said question,
idea from the student related to said question,
illustrative example from the student related to said question, and
instruction from the teacher to the student.
